(19) United States
(12) Patent Application Publication
(10) Pub. No.: US 2014/0344035 A1
(43) Pub. Date: Nov. 20, 2014

(54) MANAGING CONTENT RECOMMENDATIONS FOR CUSTOMERS

(71) Applicant: DataSphere Technologies, Inc., Bellevue, WA (US)

(72) Inventors: Delane Robert Hewett, Bellevue, WA (US); Christopher Robert Coffman, Seattle, WA (US); Erik Olson, Seattle, WA (US); Adam Cramer, Seattle, WA (US); Gary Duncan Cowan, Issaquah, WA (US)

(21) Appl. No.: 13/917,158

(22) Filed: Jun. 13, 2013

Related U.S. Application Data
(60) Provisional application No. 61/824,642, filed on May 17, 2013.

(51) Int. Cl. G06Q 30/02

(52) U.S. Cl. CPC G06Q 30/0211
USPC 705/14.13

(57) ABSTRACT

Embodiments are directed towards recommending coupon templates to a customer, from which the customer can select and have published to consumers. A ranked order may be determined for the coupon templates for each of a plurality of categories. A subset of the coupon templates may be recommended and provided to a customer. The subset of coupon templates may be determined based on a category of the customer, the ranked order of the plurality of coupon templates for the category, external variables, or the like, or any combination thereof. One or more of the subset of coupon templates may be selected by the customer and published to the consumers. The ranked order of the plurality of coupon templates may be determined and/or modified based on monitored actions associated with previously published coupons, such as by employing a success of similar attributes associated with previously published coupons.

### CROSS-REFERENCE TO RELATED APPLICATIONS

This application claims the benefit under 35 U.S.C. §119(e) of U.S. Provisional Patent Application Ser. No. 61/824,642 filed on May 17, 2013, which is incorporated herein by reference.

### TECHNICAL FIELD

The present invention relates generally to content management, and more particularly to, generating content recommendations for businesses to employ in promotions that encourage consumers to obtain its products.

### BACKGROUND

Today, most businesses rely on some form of promotion to entice customers to purchase its products, access its websites, or visit its physical facility such as a retail store or showroom. These promotions generally include advertisements that inform a consumer about a product and a coupon for a discount and/or a free sample of the product. A large regional or national business can easily afford to hire an advertising agency to research and create customized promotions directed to consumers of the business's products. Unfortunately, most small businesses do not have the financial resources to hire advertising agencies for such customized promotions. Instead, they typically rely upon more generic “canned” promotions that are less effective. Although a small business may know that its generic promotion is less effective than a customized promotion created by an advertising agency, the economic scale of the small business usually does not justify the extra cost. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client device that may be included in a system such as that shown in FIG. 1;

FIG. 3 shows an embodiment of a network device that may be included in a system such as that shown in FIG. 1;

FIG. 4 illustrates a logical flow diagram generally showing one embodiment of an overview process for recommending content templates to a customer and modifying a ranked order of the content templates based on monitored actions of published contents;

FIG. 5 illustrates a logical flow diagram generally showing one embodiment of a process for modifying a ranked order of content templates based on monitored actions by consumers;

FIG. 6 illustrates a logical flow diagram generally showing one embodiment of a process for modifying content templates based on consumer customizations of content templates;

FIG. 7 illustrates a logical flow diagram generally showing one embodiment of a process for determining and utilizing published content attribute successes to rank order and/or recommend content templates;

FIG. 8 shows a non-exhaustive example of a use case embodiment of a system-flow diagram generally showing embodiments for recommending content to customers for publication to consumers;

FIG. 9 shows a non-exhaustive example of a use case embodiment of a graphical user interface that may be utilized to view content templates and their rankings; and

FIG. 10 shows a non-exhaustive example of a use case embodiment of a graphical user interface that displays content template information.

### DETAILED DESCRIPTION

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “customer” may refer to an individual person, partnership, organization, corporate entity, or the like that operates as a separately identifiable business that contracts with a content recommendation system. In at least one of the various embodiments, the customer may purchase, license, lease, or otherwise obtain recommendations for content, such as a content template, from a content recommendation system. The customer may sell or provide a product to consumers through a website or at a physical facility such as a retail store, showroom, warehouse, office, restaurant, and the like. In at least one of various embodiments, a customer may also be referred to as a retailer, vendor, professional, products provider, user of the content recommendation system, or the like.

As used herein, the term “consumer” may refer to an individual person, partnership, organization, or corporate entity that may purchase, license, lease, or otherwise obtain one or more products from a customer, where the consumer and the customer are different and separately identifiable.

As used herein, the term “product” may refer to a good and/or service that a customer offers and/or otherwise provides to one or more consumers.

As used herein, the term “coupon” may refer to a type of content that entitles the holder (e.g., a consumer) of the coupon to redeem a discount on and/or obtain a free product offered by a customer. In some embodiments, a coupon may be related to a particular product and/or a type of product offered by the customer. Example coupons may include, but are not limited to, “Buy 1 Get 1 Free,” “Free Beverage with $5 purchase,” “Free 1 hour consultation,” “$20 off purchase,” “30% off a $100 purchase,” or the like. In at least one embodiment, products that are relatively less expensive, such as food, may be associated with a coupon that offers the product for free. Also, other products that are relatively more expensive, such as professional services, may be associated with coupons that offer the product at a discount.

In at least one of the various embodiments, coupons may be provided to consumers in a variety of different environments or through a variety of different channels. Also, a customer may be enabled to provide a coupon to a consumer through different environments or through a variety of different channels. For example, coupons may be provided to consumers through webpages, emails, relay chat messages, text messages, MMS messages, social networks such as Facebook, micro-blog posts such as Twitter, postal mailings, flyers, posters, billboards, television advertisements, radio advertisements, and the like. In some embodiments, a coupon may be distinguished from other published content by a color, an outline, border, a dashed line, or the like to give the visual effect of a separation from other published content. A coupon may include instructions that identify how the coupon can be redeemed, which may include, but are not limited to, entering a coupon identifier and/or code on a website, presenting a physical copy of the coupon to the customer, presenting an image of the coupon on a mobile device to the customer, or the like.

Coupons may also include coupon templates. As used herein, the term “coupon template” may refer to a coupon that can be modified or changed by a customer prior to and/or during publication of the coupon. Such modifications may include, but are not limited to, changing a value and/or discount of a coupon template; adding text, image, or graphic to a coupon template; changing a format of a coupon template (e.g., color, font, layout, or the like); modifying or adding an attribute to a coupon template; or the like.

As used herein, the term “content” may refer to any information and/or data that can be provided to a consumer including textual, graphical, and/or audio content. Content may include online content, videos, images, animation, graphics, illustrations, audio files, text, text messages, emails, documents, posters, flyers, letters, or the like which can be used in product promotions for targeted advertisements, product information, customer information, coupons, or the like.

As used herein, the term “content template” may refer to content that can be modified or changed by a customer prior to and/or during publication of the content. Such modifications may include, but are not limited to, changing a value and/or discount of a content template; adding text, images, videos, or graphics to a content template; changing a format of a content template (e.g., color, font, layout, or the like); modifying or adding an attribute to a content template; or the like.

As used herein, the term “category” may refer to a classification of a customer and/or content. Example categories include, but are not limited to “Health and Beauty,” “Automotive,” “Travel,” or the like. Categories may also be referred to in some embodiments as business categories. Also, in at least one embodiment, a customer and content may be classified by more than one category.

As used herein, the terms “actions” and/or “monitored actions” may refer to a behavior or act being performed on and/or with content. Actions may include online and/or offline behaviors, such as clicking on content, redeeming a coupon, or the like. In some embodiments, actions may be performed by a consumer on published content (e.g., videos, banners, coupons, or the like). These actions may include, but are not limited to searching, viewing, mousing over, scrolling, selecting, reading, clicking on, printing, sharing, redeeming, or the like. In other embodiments, actions may be performed by a customer on content, such as, but not limited to, modifying a content template and/or other content provided in an advertisement template.

As used herein, the term “external variable” may refer to information and/or statistics associated with a customer and/or content that are unrelated to actions performed by consumers on previously published content for the customer. Examples of external variables may include, but are not limited to, a location of the customer, a third party identified reputation of the customer, a dollar amount associated with products sold by the customer (e.g., an average dollar amount of products), a dollar amount associated with a product that corresponds to the coupon, seasonal trends, consumer or customer feedback, a value of a coupon, or the like.

As used herein, the term “success” may refer to a metric and/or value that indicates how successful content and/or attributes perform when published to a plurality of consumers. In some embodiments, the success may be determined based on one or more factors, e.g., the number of clicks per impression, percentage of coupons redeemed, rate of redemption of coupons, or the like. In at least one of various embodiments, a conversion rate may be determined for each separate action type and a success may be determined based on a combination or weighted combination of these conversion rates. In some embodiments, the success may be represented as a value, such that a success of one coupon may be compared to another coupon. A best performing content may the content with a highest success when compared to other published content. For example, a best performing coupon may be one or more coupons with a highest success when compared to other coupons.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to providing recommendations of content for a promotion of a customer's product. The customer can select, edit, and provide the recommended content to a plurality of consumers. In at least some of the various embodiments, the content recommendation may be one or more content templates, such as, coupon templates. A ranked order may be determined for a plurality of content templates for each of a plurality of categories based at least on previous consumer actions associated with at least a portion of the plurality of content templates, such as, coupon templates. Exemplary categories may include, but are not limited to, “Health and Beauty,” “Legal,” “Dentist,” “Doctor,” “Home Repair,” “Automotive,” “Travel,” “Dry Cleaner,” “Florist,” or the like.

A subset of the plurality of coupon templates may be recommended and provided to a customer. In at least one of various embodiments, the subset of the plurality of coupon templates may be determined based on at least one of a category of the customer and the ranked order of the plurality of coupon templates for the category. Also, in at least one of the embodiments, the subset of the plurality of content templates may further be determined based on a weighted combination of at least the ranked order and one or more external variables that are unrelated to consumer actions associated with the plurality of content templates. In yet other embodiments, the subset of the plurality of content templates may further be determined based on a third-party identified reputation of the customer. In at least one of the various embodiments, the subset of the plurality of content templates may further be determined based on a cost of the product offered to the consumer for redemption. In at least one of various embodiments, the customer may be enabled to modify at least one of the subset of content templates. The customer may be enabled to select at least one of the subset of content templates for publication. In at least one embodiment, the customer may be enabled to select one or more of a plurality of highest ranked content templates from the subset of content templates based on a single selection. The selected one or more content templates may then be finalized and published as content to a plurality of consumers for one or more products of the customer.

In at least one of the embodiments, actions on the published content may be monitored. In some embodiments, the monitored actions may include one or more interactions performed by at least some of the plurality of consumers on the published content, including, but not limited to, searching, viewing, clicking on, hover over, printing, or sharing the published content. In other embodiments, the monitored actions may include interactions performed by the customer on published content, such as, one or more published coupons, such as editing and/or customizing at least a portion of one or more content templates. Based on a plurality of monitored actions associated with the published content, the ranked order of the plurality of content templates may be modified to include one or more versions of content templates that are edited by one or more consumers.

In some embodiments, the ranked order of the plurality of content templates may be determined and/or modified based on a success of each attribute associated with previously published content. The success of each attribute may be determined based on a plurality of monitored actions associated with previously published content. A score may then be determined for a given content template based on the success of each attribute that is associated with the subsequently published content. A score may be determined for each of the plurality of content templates based on a success of attributes associated with the corresponding published content. The ranked order of the plurality of content templates may be determined and/or modified based on one or more of these scores, which may be separately weighted.

Although described primarily in terms of coupons or coupon templates, similar embodiments may be employed to recommend other types of content to customers. For example, at least one of the embodiments described herein may similarly be employed to recommend to customers at least one of other types of content, such as advertisement templates, advertisements, videos, pictures, graphics, illustrations, text, text formatting, background color(s), foreground color(s), audio content, or the like. Also, in at least one of various embodiments described herein, the term “coupon” or “coupon template” may be replaced throughout the figures and description of the figures with the more general term “content.”

### Illustrative Operating Environment

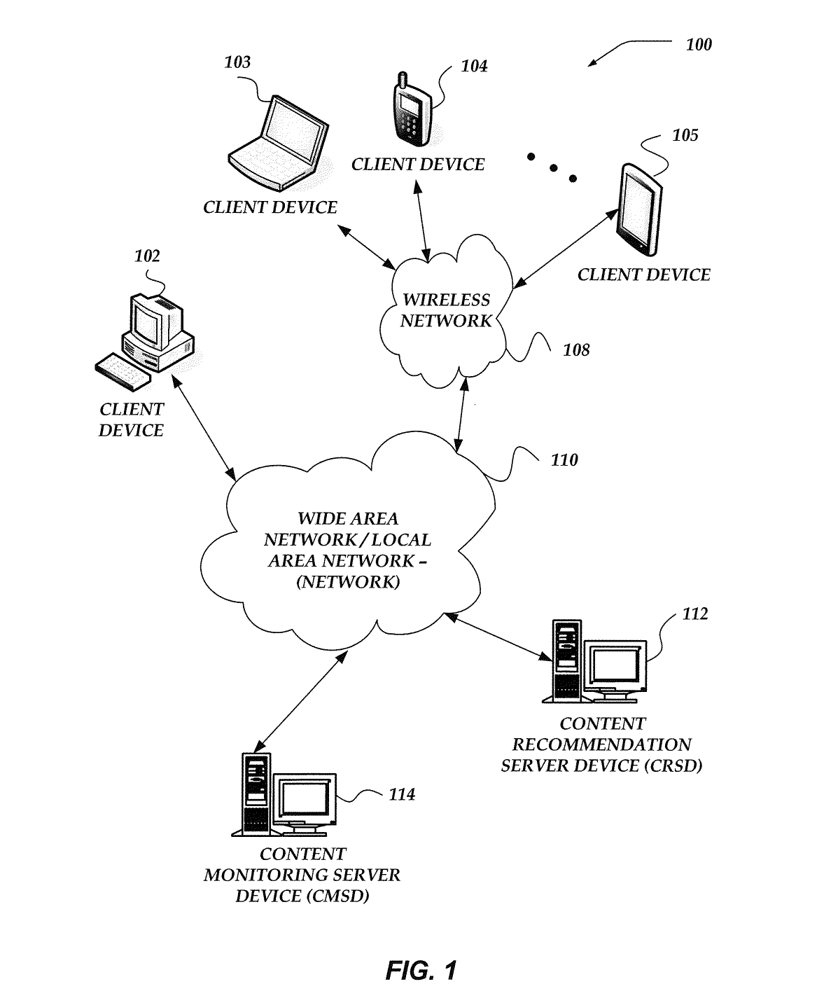

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)-(network) 110, wireless network 108, client devices 102-105, Content Recommendation Server Device (CRSD) 112, and Content Monitoring Server Device (CMSD) 114.

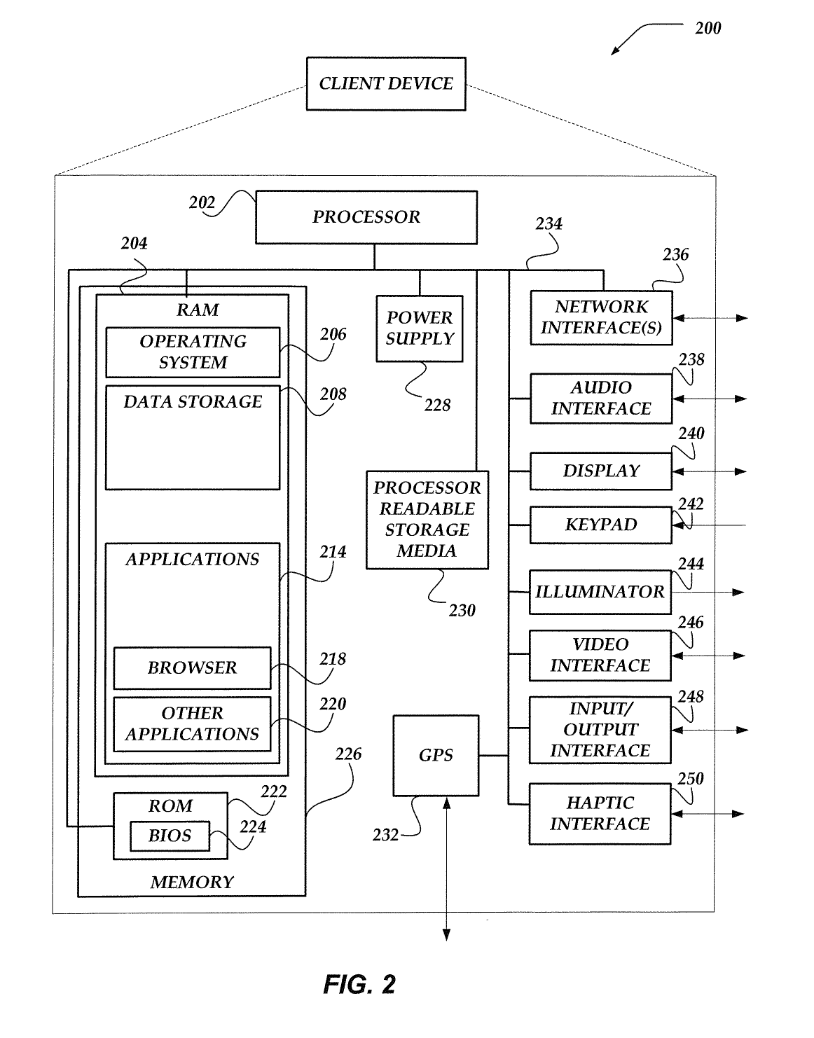

At least one embodiment of client devices 102-105 is described in more detail below in conjunction with FIG. 2. In one embodiment, at least some of client devices 102-105 may operate over a wired and/or wireless network, such as networks 110 and/or 108. Generally, client devices 102-105 may include virtually any computing device capable of communicating over a network to send and receive information, perform various online activities, offline actions, or the like. In one embodiment, one or more of client devices 102-105 may be configured to operate within a business or other entity to perform a variety of services for the business or other entity. For example, client devices 102-105 may be configured to operate as a web server, an accounting server, a production server, an inventory server, or the like. However, client devices 102-105 are not constrained to these services and may also be employed, for example, as an end-user computing node, in other embodiments. It should be recognized that more or less client devices may be included within a system such as described herein, and embodiments are therefore not constrained by the number or type of client devices employed.

Devices that may operate as client device 102 may include devices that typically connect using a wired or wireless communications medium such as personal computers, multiprocessor systems, microprocessor-based or programmable electronic devices, network PCs, or the like. In some embodiments, client devices 102-105 may include virtually any portable personal computing device capable of connecting to another computing device and receiving information such as, laptop computer 103, smart mobile telephone 104, and tablet computers 105, and the like. However, portable computing devices are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client devices 102-105 typically range widely in terms of capabilities and features. Moreover, client devices 102-105 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client device may employ the browser application to perform various activities over a network (online). However, another application may also be used to perform various online activities.

Client devices 102-105 also may include at least one other client application that is configured to receive and/or send content between another computing device. The client application may include a capability to send and/or receive content, or the like. The client application may further provide information that identifies itself, including a type, capability, name, and the like. In one embodiment, client devices 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client devices, CRSD 112, CMSD 114, or other computing devices.

Client devices 102-105 may further be configured to include a client application that enables an end-user to log into an end-user account that may be managed by another computing device, such as CRSD 112, CMSD 114, or the like. Such end-user account, in one non-limiting example, may be configured to enable the end-user to manage one or more online activities, including in one non-limiting example, search activities, social networking activities, browse various websites, communicate with other users, or the like. However, participation in such online activities may also be performed without logging into the end-user account.

Wireless network 108 is configured to couple client devices 103-105 and its components with network 110. Wireless network 108 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client devices 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client devices 103-105 and another computing device, network, and the like.

Network 110 is configured to couple network devices with other computing devices, including, CRSD 112, CMSD 114, client device 102, and client devices 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

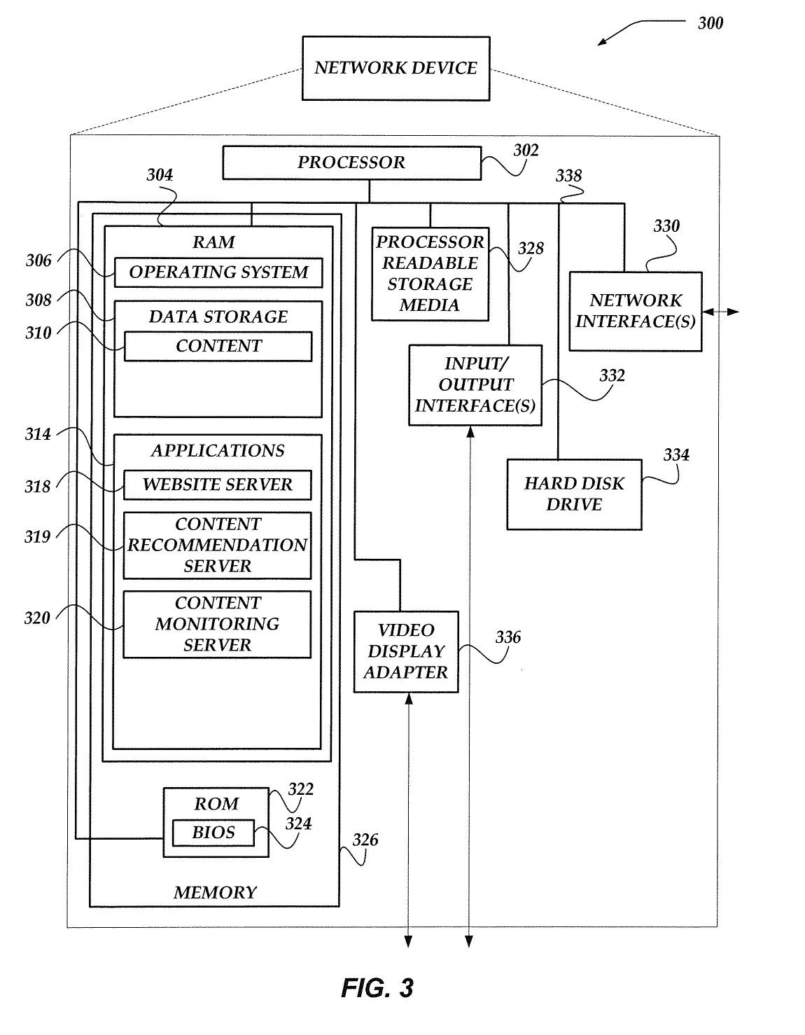

One embodiment of CRSD 112 is described in more detail below in conjunction with FIG. 3. Briefly, however, CRSD 112 includes virtually any network device capable of ranking a plurality of coupons and/or coupon templates for each of a plurality of different categories and recommending a subset of a plurality of coupon templates to a customer. In at least one embodiment, CRSD 112 may determine which coupons to recommend to a customer based on a plurality of factors, including, but not limited to, a ranked order of the plurality of coupon templates, a category of the customer, one or more external variables (e.g., a reputation of the customer, a location of the customer, or a dollar amount associated with a coupon), or the like. In some embodiments, CRSD 112 may enable a customer to generate a new coupon and/or modify a coupon template. The customer may be enabled to select and finalize at least one coupon template for publication. Devices that may be arranged to operate as CRSD 112 include various network devices, including, but not limited to personal computers, desktop computers, multiprocessor systems, microprocessor-based or programmable consumer electronics, network PCs, server devices, network appliances, and the like.

Although FIG. 1 illustrates CRSD 112 as a single computing device, the invention is not so limited. For example, one or more functions of the CRSD 112 may be distributed across one or more distinct network devices. Moreover, CRSD 112 is not limited to a particular configuration. Thus, in one embodiment, CRSD 112 may contain a plurality of network devices. In another embodiment, CRSD 112 may contain a plurality of network devices that operate using a master/slave approach, where one of the plurality of network devices of CRSD 112 is operative to manage and/or otherwise coordinate operations of the other network devices. In other embodiments, the CRSD 112 may operate as a plurality of network devices within a cluster architecture, a peer-to-peer architecture, and/or even within a cloud architecture. Thus, the invention is not to be construed as being limited to a single environment, and other configurations, and architectures are also envisaged.

One embodiment of CMSD 114 is described in more detail below in conjunction with FIG. 3. Briefly, however, CMSD 114 includes virtually any network device capable of monitoring actions associated with published coupons. In some embodiments, the coupons may be published by CRSD 112, CMSD 114, or another network device (e.g., a web server) (not shown). CMSD 114 may determine statistics regarding the published coupons and/or specific attributes of each published coupon. Devices that may be arranged to operate as CMSD 114 include various network devices, including, but not limited to personal computers, desktop computers, multiprocessor systems, microprocessor-based or programmable consumer electronics, network PCs, server devices, network appliances, and the like.

Although FIG. 1 illustrates CMSD 114 as a single computing device, the various embodiments are not so limited. For example, one or more functions of the CMSD 114 may be distributed across one or more distinct network devices. Moreover, CMSD 114 is not limited to a particular configuration. Thus, in one embodiment, CMSD 114 may contain a plurality of network devices. In another embodiment, CMSD 114 may contain a plurality of network devices that operate using a master/slave approach, where one of the plurality of network devices of CMSD 114 operates to manage and/or otherwise coordinate operations of the other network devices. In other embodiments, the CMSD 114 may operate as a plurality of network devices within a cluster architecture, a peer-to-peer architecture, and/or even within a cloud architecture. Thus, the invention is not to be construed as being limited to a single environment, and other configurations, and architectures are also envisaged.

Although illustrated separately, CRSD 112 and CMSD 114 may be employed as a single network device, separate network devices, a cluster of network devices, or the like. In some embodiments, either CRSD 112 or CMSD 114, or both, may be enabled to rank coupon templates and/or modify the rankings in real time as coupon templates are being recommended and/or modified by customers, as coupons are published and/or acted on by consumers, or the like, or any combination thereof.

### Illustrative Client Device

FIG. 2 shows one embodiment of client device 200 that may be included in a system implementing embodiments of the invention. Client device 200 may include many more or less components than those shown in FIG. 2. However, the components shown are sufficient to disclose an illustrative embodiment for practicing the present invention. Client device 200 may represent, for example, one embodiment of at least one of client devices 102-105 of FIG. 1.

As shown in the figure, client device 200 includes a processor 202 in communication with a mass memory 226 via a bus 234. In some embodiments, processor 202 may include one or more central processing units (CPU). Client device 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to client device 200. A rechargeable or non-rechargeable battery may be used to provide power. The power may also be provided by an external power source, such as an alternating current (AC) adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the client device is powered. Also, illuminator 244 may backlight these buttons in various patterns when particular actions are performed, such as dialing another client device. Illuminator 244 may also cause light sources positioned within a transparent or translucent case of the client device to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client device. For example, the haptic interface 250 may be employed to vibrate client device 200 in a particular way when another user of a computing device is calling. In some embodiments, haptic interface 250 may be optional.

Client device 200 may also include GPS transceiver 232 to determine the physical coordinates of client device 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client device 200 on the surface of the Earth. It is understood that under different conditions, GPS transceiver 232 can determine a physical location within millimeters for client device 200; and in other cases, the determined physical location may be less precise, such as within a meter or significantly greater distances. In one embodiment, however, mobile device 200 may through other components, provide other information that may be employed to determine a physical location of the device, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of network device 200, including, but not limited to processor readable storage media 230, a disk drive or other computer readable storage devices (not shown) within client device 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computing device. Processor readable storage media 230 may also be referred to herein as computer readable storage media and/or computer readable storage device.

Applications 214 may include computer executable instructions which, when executed by client device 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client device. Applications 214 may include, for example, browser 218, and other applications 220. Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client device 200 to communicate with another network device, such as CRSD 112 and/or CMSD 114 of FIG. 1.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, a host, or any other device. Network device 300 may represent, for example CRSD 112 and/or CMSD 114 of FIG. 1, and/or other network devices.

Network device 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network device 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network device 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network device 300. Any general-purpose operating system may be employed. Basic input/output system (BIOS) 324 is also provided for controlling the low-level operation of network device 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 326 further includes one or more data storage 308, which can be utilized by network device 300 to store, among other things, applications 314 and/or other data such as content 310. For example, data storage 308 may also be employed to store information that describes various capabilities of network device 300. The information may then be provided to another device based on any of a variety of events, including being sent as part of a header during a communication, sent upon request, or the like. Data storage 308 may also be employed to store messages, web page content, or the like. At least a portion of the information may also be stored on another component of network device 300, including, but not limited to processor readable storage media 328, hard disk drive 334, or other computer readable storage medias (not shown) within client device 300

Data storage 308 may include a database, text, spreadsheet, folder, file, or the like, that may be configured to maintain and store user account identifiers, user profiles, email addresses, IM addresses, and/or other network addresses; or the like. Data storage 308 may further include program code, data, algorithms, and the like, for use by a processor, such as processor 302 to execute and perform actions. In one embodiment, at least some of data store 308 might also be stored on another component of network device 300, including, but not limited to processor-readable storage media 328, hard disk drive 334, or the like.

Applications 314 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 314 may also include website server 318, Content Recommendation Server (CRS) 319, and Content Monitoring Server (CMS) 320.

Website server 318 may represents any of a variety of information and services that are configured to provide content, including messages, over a network to another computing device. Thus, website server 318 can include, for example, a web server, a File Transfer Protocol (FTP) server, a database server, a content server, or the like. Website server 318 may provide the content including messages over the network using any of a variety of formats including, but not limited to WAP, HDML, WML, SGML, HTML, XML, Compact HTML (cHTML), Extensible HTML (xHTML), or the like.

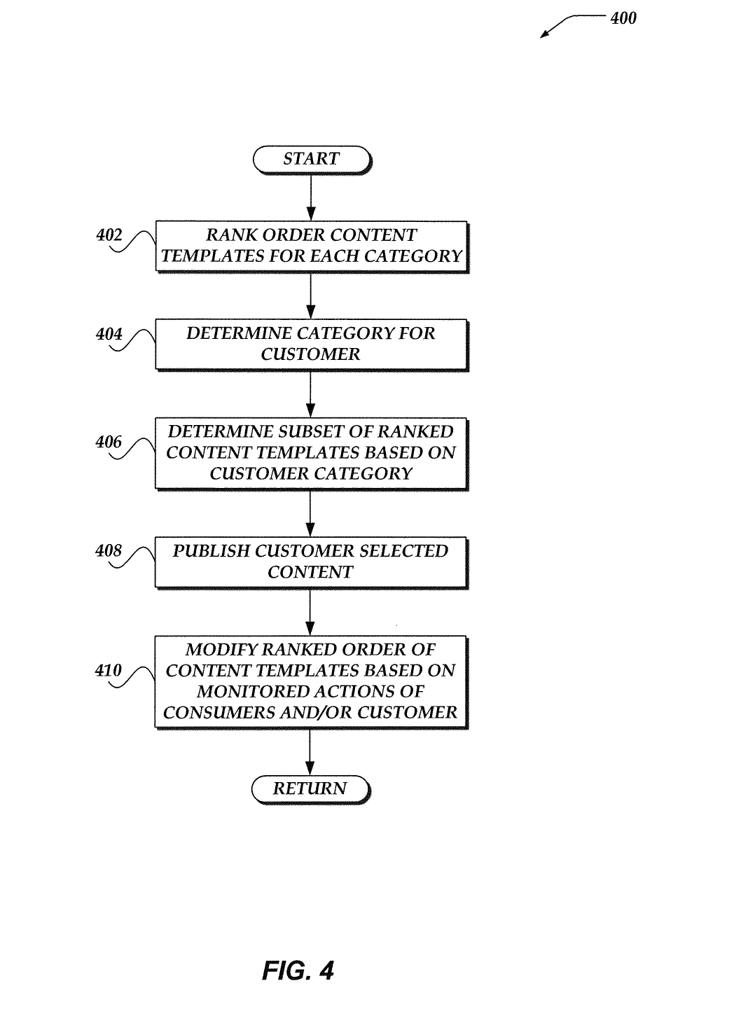

CRS 319 may be configured to determine one or more coupon templates to recommend to a customer. In at least one embodiment, CRS 319 may rank order a plurality of coupon templates for each of a plurality of categories. A subset of the plurality of coupon templates may be recommended to the customer based on the rankings, external variables, or the like. In some embodiments, CRS 319 may be employed by CRSD 112 of FIG. 1. In any event, CRS 319 may employ processes, or parts of processes, similar to those described in conjunction with FIGS. 4-7, to perform at least some of its actions.

CMS 320 may be configured to monitor actions associated with published coupons. In some embodiments, CMS 320 may be employed by CMSD 114 of FIG. 1. In any event, CMS 320 may employ processes, or parts of processes, similar to those described in conjunction with FIGS. 4-7, to perform at least some of its actions.

### General Operation

The operation of certain aspects of the invention will now be described with respect to FIGS. 4-7. In at least one of various embodiments, processes 400, 500, 600, and 700 described in conjunction with FIGS. 4-7, respectively, may be implemented by and/or executed on a single network device, such as network device 300 of FIG. 3. In other embodiments, these processes or portions of these processes may be implemented by and/or executed on a plurality of network devices, such as network device 300 of FIG. 3. However, embodiments are not so limited and various combinations of network devices, or the like, may be utilized.

FIG. 4 illustrates a logical flow diagram generally showing one embodiment of an overview process for recommending a particular type of content, content templates, such as, coupon templates, to a customer and modifying a ranked order of the content templates based on monitored actions of finalized content that is published to consumers. Process 400 begins, after a start block, at block 402, where a plurality of content templates may be rank ordered for each of a plurality of categories. In at least one of the various embodiments, one or more of the plurality of content templates may be modified or unmodified by the customer as part of the finalization of one or more portions of content, such as, coupons for subsequent publication to the customer's existing and potential consumers of its products. In at least one of the various embodiments, each portion of published content may be separately identified with a unique identifier or code that is associated with at least one promotion. In yet another of the various embodiments, each portion of the published content may be identified with an identifier or code for at least one promotion associated with a product offered by the customer.

In at least one embodiment, the plurality of content templates may be arranged as a library of different types of content templates, some (one or more) of which can be recommended to a customer for use in promoting its product to consumers.

In at least some embodiments, an initial ranking of the content templates may be determined by an administrator or sales representative, randomly determined, equally ranked, unranked, or the like. In other embodiments, historical data may be utilized to rank the plurality of content templates. For example, the plurality of content templates, may include coupon templates that may be rank ordered based on how well published coupons based on the coupon templates performed in the past, or how successful a previous publication of a coupon was. In some embodiments, process 400 may be repeated for a plurality of different customers and/or a plurality of different content template requests from customers. In at least one such embodiment, the ranked order of the content templates at block 402 may be determined at block 410 of a previous execution of process 400. So, in some embodiments, the ranked order of content templates may dynamically change over time as different and/or additional content may be published and monitored.

Ranking the order of the content templates may include a stacked rank or ordered rank such that each content template is ranked differently and none or very few of the content templates have the same ranking. An example of such a numerical stacked ranking may be that the content templates, such as, coupon templates are ranked from 1 to x, where 1 is a best performing coupon template (for published coupons generated from the coupon template), and x is the worst performing coupon template (for published coupons generated from the coupon template) and is equal to the number of coupon templates. In yet other embodiments, the plurality of content templates may be rated, where one or more content templates may have a same rating. For example, some content templates, such as, 10 coupon templates may have a rating of “A” (for best performing), while 50 coupon templates may have a rating of “F” (for worst performing).

However, embodiments are not so limited and other mechanism for rankings and/or ratings the plurality of content templates may be employed. For example, in some other embodiments, a plurality of coupon templates may be put into groups/buckets. Determining which coupon templates belong to each group/bucket may be based on the ratings and/or rankings. In at least one of various embodiments, each group/bucket may have a predetermined minimum and/or maximum number of coupon templates. In one non-limiting, non-exhaustive example, each group/bucket may include a set of five coupon templates, where group_{—}1 includes the five coupon templates with the highest ranking, group_{—}2 includes the five coupon templates with the next highest ranking, and so forth. These groups/buckets may be utilized to provide recommended coupon templates to customers (e.g., at block 406). In at least one such embodiment, each coupon template associated with a given group/bucket may be provided to a customer.

In some embodiments, the plurality of content templates, such as coupon templates, may be separately ranked for each of a plurality of categories. So, in at least one of various embodiments, each coupon template may be separately ranked for each separate category. In one non-limiting, non-exhaustive example, Coupon_A may be ranked the 10th best coupon template for a “Health and Beauty” category, but 324^{th} best coupon template for an “Automotive” category. The different categories may be determined based on different types of business categories for which the coupon templates may be used, such as, for example, “Health and Beauty,” “Automotive,” “Travel,” or the like.

In some other embodiments, the plurality of content templates may be separately ranked for sub-categories of the categories, where one or more of the categories may include one or more sub-categories. In at least one of various embodiments, sub-categories may be a division or specific subsection of a generic category. For example, the category “Automotive” may include the sub-categories “Trucks,” “Cars, “Classics,” or the like. In various other embodiments, the sub-categories may be based on external variables that are unrelated to the category or to the content template. Non-limiting, non-exhaustive examples of such external variable sub-categories may include geography, reputation rating/ranking, dollar amount of products sold by a customer (e.g., an average price of customer products, dollar amount of a product associated with a coupon, seasonal trends, or the like.

In some embodiments, the plurality of content templates may be separately ranked for each of a plurality of different external variables. For example, in some embodiments, the plurality of content templates, may include a plurality of coupon templates that may be separately ranked for each of a plurality of different geographic locations for each category (e.g., by state, city, zip code, zip+4, or the like). In other embodiments, the plurality of coupon templates may be separately ranked for each of a plurality of different reputation ratings. For example, the plurality of coupon templates may be separately ranked for each category for customers with a “five star” reputation, for customers with a “four star” reputation, and so on. In yet other embodiments, the plurality of coupon templates may be separately ranked for each of a plurality of different product values or levels of product values. For example, the plurality of coupon templates may be separately ranked for each category for products between $1 and $5, for products between $6 and $25, and so on. In other embodiments, seasonal trends may be associated with a value or different products. Also, in some embodiments, coupon templates may be ranked and/or rated for different combinations of external variables. For example, a coupon template for “buy one get one free” may be ranked lower than a 20% off coupon template for businesses with a five star reputation rating but may be ranked higher for businesses with a one start rating. However, embodiments are not so limited, and that values/ratings and/or combinations of external variables is for illustrative purposes and other values/ratings of external variables (and different types of external variables) may be employed.

In some other embodiments, the external variables may also be based on validity dates of a content template. For example, a particular coupon template for a “professional services” category may be ranked higher than other coupon templates if it is valid “Monday's only,” but lower for a “restaurant” category. However, embodiments are not so limited and other external variables and combinations of external variables may be utilized as categories, sub-categories, or otherwise to rank content templates.

In any event, process 400 may proceed to block 404, where a category may be determined for a customer. In some embodiments, a customer may provide a request for one or more recommended content templates. In at least one of various embodiments, the request may include metadata or other tags that indicate which categories the customer is associated with. In another embodiment, a database may store and/or maintain which customers are associated with each category, such that in response to a request for recommended coupon templates, the database may be queried to determine the category of the customer.

In some embodiments, a sub-category may also be determined for a customer. In some embodiments, the customer may provide the sub-category, such as if the customer requests content templates for a specific geographic location, coupon value, or the like. In other embodiments, the sub-category may be provided by a third party, such as, but not limited to a reputation collection website.

Process 400 may continue at block 406, where a subset of the ranked content templates may be determined based on the customer category. In at least one of various embodiments, the subset of ranked content templates may be recommended content templates that may be provided to the customer. The subset of content templates may include one or more of the plurality of content templates. In other embodiments, the subset of the ranked content templates may be determined based on one or more (or a combination) of customer sub-categories.

In some embodiments, the subset of content templates may be determined based on a combination of the ranked order of the content templates (as determined at block 402) and/or one or more external variables. The external variables may include information and/or statistics associated with the customer that is unrelated to actions performed by consumers on previously published content for the customer. Examples of external variables that may be related to content templates, such as, coupon templates, may include, but is not limited to, a location of the customer, a third party identified reputation of the customer, a dollar amount associated with products sold by the customer (e.g., an average dollar amount of products), a dollar amount associated with a product that corresponds to the coupon, seasonal trends, or the like.

In some embodiments, the ranking and the external variables may be weighted to determine which content to recommend to the customer as the subset of content templates. One example of a combination of the ranked order and the external variables may include a weighted sum of the ranked order and one or more external variables (where each external variable may be associated with a value).

In other embodiments, the subset of content templates may be determined based on sub-categories of the customer category. In at least one such embodiment, additional information associated with the customer may be obtained to determine the sub-categories. For example, in some embodiments, the customer may provide a geographic region (e.g., a sub-category of the determined customer category) of the where it would like recommended content templates. The geographic region may utilize various aspects of the physical location identified, such as, but not limited to, urban v. suburbia, stand alone v. clustered (e.g., a mall), or the like. For example, if the customer is enabled to select an urban location, then the subset of content templates may include more restaurant related content templates, rather than automobile related content templates. In other embodiments, the customer may provide a dollar amount of a product to be associated with a recommended content template (e.g., for coupon templates).

In other embodiments, a third party may be queried to obtain information regarding the customer. For example, a third party may maintain a reputation of the customer (e.g., a review website), which may be utilized to determine a sub-category for determining the subset of content templates.

In yet other embodiments, consumer and/or customer feedback may be employed. For example, a customer may provide feedback on a value associated with a lead or redemption of published content. In one non-limiting, non-exhaustive example, assume a law firm publishes a coupon for a “buy one hour, get one hour free,” which equates to a $200 savings for the consumer. In this example, the law firm may provide feedback that indicates the true value or lead for the new client is $500, rather than $200. In some embodiments, a lead may be more valuable to a professional service, than a restaurant, so feedback from the customers on the lead value may be utilized to further rank and/or determine a subset of content templates for a customer. In any event, various combinations of external variables may be utilized to determine to the subset of content templates for a customer.

In some other embodiments, the number of content templates included in the subset may be a predetermined number. In other embodiments, the customer may be enabled to select and/or determine the number of content templates included in the subset. In various embodiments, the subset may include a highest ranked number of content templates (compared to a ranking of other content templates) for the particular category that the customer is associated. For example, assume the determined customer category is “Automotive,” the subset of ranked content templates may include the three highest ranking content templates for the automotive category. In at least one of various embodiments, the customer may be enabled request additional subsets of content templates, such as by selecting a button in a graphical user interface for a next best subset of content templates.

In some other embodiments, the subset of content templates may include content templates from a group/bucket that each has a same rating. In at least one embodiment, the customer may be enabled to select a minimum rating for the group/bucket of content templates to recommend to the customer.

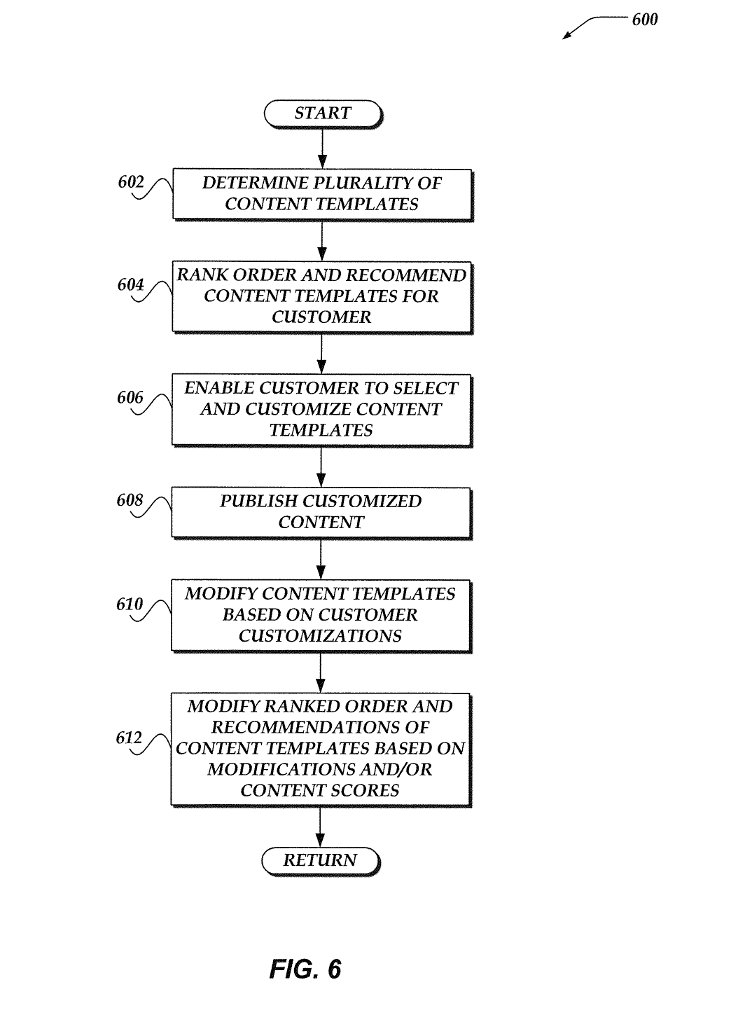

The subset of content templates may be provided and/or otherwise displayed to the customer, such as through a graphical user interface (GUI). In some embodiments, the customer may be enabled to select one or more of the subset of content templates for publication to consumers. In some embodiments, the customer may be enabled to select all of the subset of content templates (e.g., if the subset includes multiple content templates) by providing a single selection (e.g., by clicking on a single GUI button). In other embodiments, the customer may be enabled to modify a selected content template, which is described in more detail in conjunction with FIG. 6. In at least one of various embodiments, finalization of a content template may include a selection of at least one of the content templates for publication. In another embodiment, finalization of a content template may include customizing the content template (e.g., including a business name, changing an attribute, or the like) and selecting the customized content for publication.

Process 400 may proceed next to block 408, where one or more of the subset of content templates may be published. In some embodiments, the customer may be enabled to select one or more of the subset of content templates for publication. Publishing the customer selected content, such as, selected coupons may include providing the selected coupons to one or more consumers of products of the customer. In some embodiments, a mailing list of the customer may be utilized to determine which consumers to provide the selected content (which may be referred to as private consumers). In other embodiments, the selected content may be generally published and/or accessible to the public (which may be referred to as public consumers). Examples of publishing the selected content may include posting the selected content to a website (e.g., if a consumer accesses the website, provides a search for content and/or coupons, or the like), emailing the selected content to consumers, sending the selected content to the consumers via SMS or MMS, or the like.

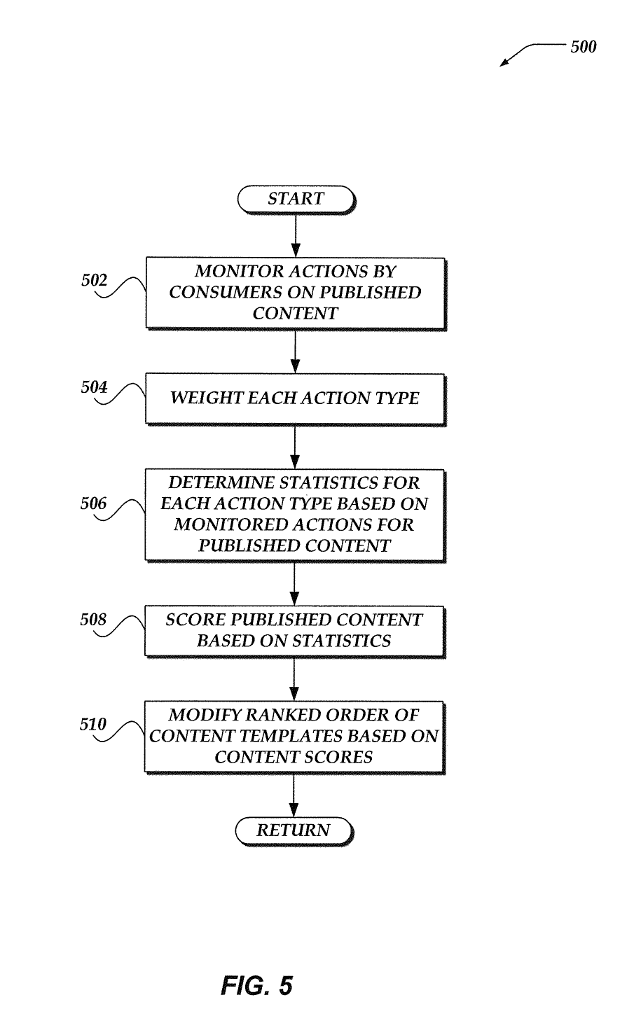

In any event, process 400 may continue next at block 410, where the ranked order of the plurality of content templates for the category of the customer may be modified. The modifications to the ranked order may be determined based on monitored actions of consumers and/or the customer on published content generated based on content templates. Various embodiments for modifying the ranked order are described below in conjunction with FIGS. 5-7. In some embodiments, blocks 404, 406, and 408 may be employed for a plurality of customers and/or for a plurality of published content prior to modifying the ranked order of the plurality of content templates at block 410. In at least one of various embodiments, the plurality of content templates may be re-ranked based on the monitored actions.

In some embodiments, customers may be offered a guaranteed performance of some published content, such as, a published coupon (e.g., at block 406 of FIG. 4). In at least one of various embodiments, statistics of monitored actions for published content, such as, a plurality of published coupons (e.g., as determined at block 506 of FIG. 5) may be employed to determine an average number of actions per time period (e.g., per month) and the 90th percentile for a content template. Based on these statistics, the system may guarantee that a content template selected by a customer (e.g., at blocks 406 and/or 408 of FIG. 4) for publication receive at least the 90th percentile actions per time period. For example, if a particular content template yields 11 actions per month on average and the 90th percentile yields 8, then the system may guarantee that if the particular content (generated based on the content template) for the customer does not average 8 actions per month over a six month period, then the customer may not charged for the recommended content template. In at least one such embodiment, the customer may not be charged until the average number of actions increases to or above the guaranteed action rate.

While many of the clarifying examples included herein refer to coupons and coupon templates, the innovations are not so limited. One of ordinary skill in the art will appreciate that content templates and published content is not limited to the specific examples of content types included herein. Furthermore, this description is sufficient to enable one of ordinary skill in the art to practice at least these innovations using practically any form of content and/or content type that may be presented to a user.

In at least one of the various embodiments, monitored attributes and monitored actions may vary depending on the content type of the published content. In some embodiments, a sub-set of monitored actions may be common to one or more content types. For example, actions such as, clicking, viewing, sharing, book marking, or the like, may be common to many types of content. In contrast, actions, such as, playing, stopping, “full-screening”, or the like, may be relevant for a few content types, such as video. Similarly, attributes such as, URL, display size, ess-styles, or the like, may be common to many content types. And, attributes, such as, duration, player, frames-per-second, or the like, may just be relevant for content such as video.

In at least one of the various embodiments, in addition to attributes common to other content types, published video content may include attributes, such as, frame-rate, format (e.g., HTML5, mpeg 3, or the like), bit-rate, audio format, musical soundtrack, narration, player type, player positioning, player controls (e.g., which playback controls are enabled on the player), video frame (e.g., characteristics related to the framing displayed around an embedded player) initial volume, auto-play v. push-to-start, or the like. Also, in at least one of the various embodiments, published video content, may be associated with actions, such as, playback, muting, volume adjustment, stopping playback, full-screening, pausing and continuing, re-starting playback, or the like. As with other content types, at least one or more of the above attributes and/or action may be monitored and used in part to score the video content.

Also, in at least one of the various embodiments, content type such as text based advertisement, may be monitored and analyzed similar to other text based content, such as, text based coupons. Graphics based advertisements, such as website or mobile application banner ads, may be monitored for actions such as impressions, views, clicks, or the like. Further, attributes such as, color, positioning, size, pixel density, or the like, may be tracked. In at least one of the various embodiments, image processing techniques may be applied to analyze, otherwise, opaque graphic images to look for identifiable characteristics that may be common and then used them for tracking the graphic contents performance. As with other content types, at least one or more of the above attributes and/or action may be monitored and used in part to score advertising content.

After block 410, process 400 may return to a calling process to perform other actions.

FIG. 5 illustrates a logical flow diagram generally showing one embodiment of a process for modifying a ranked order of content templates based on monitored actions by consumers. Process 500 begins, after a start block, at block 502, where actions by consumers on each portion of published content may be monitored (e.g., each published coupon). The published coontent may include the content published at block 408 of FIG. 4. In some embodiments, actions may be monitored for a plurality of separately published content for a plurality of different customers. By monitoring consumer actions, those actions may be utilized as feedback to modify rankings of content templates. So, using coupon templates as an example, coupon_template_A may move up in the ranked order of coupon templates if published coupons that originated from coupon_template_A are more successful (e.g., as determined by the monitored actions by consumers) than other published coupons that originated from coupon_template_B.

In some embodiments, the system may monitor and store information relating to each interaction performed by a plurality of consumers on each portion of published content. In some embodiments, this information may include a number of impressions per content portion. For example, the number of impressions for a given coupon may be a number of times consumers are provided the given coupon. The system may also monitor and store an indication of each time a consumer performs one or more of actions on published content. In some embodiments, the actions may be monitored on a per consumer basis, such that no matter how many times a particular consumer clicks on content (e.g., a coupon), only one click may be registered for that consumer. In other embodiments, the actions may be monitored on a per action basis, such that each click on published content is registered, no matter if it is by a same consumer or a different consumer.

The way content is published to consumers may enable the consumers to perform one or more actions on that published content. Actions performed by a consumer may be at least one of a number of different action types. Examples of different action types that may be performed by a consumer may include, but are not limited to, searching, viewing, reading, printing, sharing, adding to a favorites list, redeeming, or the like.

Searching may include a consumer utilizing a search engine to find specific topics and/or content on the internet (e.g., a consumer searching for car repair shops). However, searching is not so limited, but may also include searches for specific types of published content, such as, coupons, such as by a coupon type (e.g., 40% off), a category (e.g., “Health and Beauty”), or the like.

Viewing may include clicking on the published content, such as, clicking on a coupon to display a description of the coupon. Also, reading the content may include clicking on, mousing over, or hovering over the published content with a pointing device to display additional details about the published content (e.g., an address of the customer, a telephone of the customer, or the like).

Printing the published content, such as, a coupon may include the consumer utilizing a printer or other printing function (e.g., print screen on a mobile device) to print the coupon, which may be utilized to redeem the coupon.

Sharing the published content may include the consumer sending a link to the published content, such as a link to a coupon to a friend or other consumer. Sharing may also include the consumer posting the published content (or a link to the content) on a social media webpage.

Adding the content to a favorites list may include the consumer saving a coupon (or a link to the coupon) to a list of favorite websites or favorite coupons. Such favorites may be maintained and/or managed by a web browser, mobile application, or the like.

Redeeming the published content, such as, a coupon may include entering a redemption code associated with the coupon when a product associated with the coupon is purchased. Redeeming may also include the consumer providing a printed version of the coupon to the customer with a purchase. Such redemption information may be obtained by utilizing a barcode or other identifier on the coupon. However, embodiments are not so limited and other action types may be performed by consumers on published coupons including action on published content other than coupons.

Additionally, in at least one of the various embodiments, a consumer that obtains and/or redeems a published coupon is anonymously identified along with the published coupon. In at least one embodiment, the anonymous identification of the consumer is provided by a cookie stored on the consumer's computing device and/or fingerprinting of characteristics of the consumer's computing device. In this way, the success of various published coupons with particular consumers may be stored, and employed for determining a quantity of repeat consumers versus a quantity of new consumers that obtain coupons offered by a customer in a promotion. Based on this repeat consumer information, the coupon template rankings (and/or the subset of coupon templates provided to a customer) may be further determined and/or modified. For example, if a majority of the consumers redeeming coupons are repeat consumers, then the system may recommend an increased discount or value of a coupon template in the attempt to generate more consumer leads.

In any event, process 500 may proceed to block 504, where a weight may be determined for each action type. In some embodiments, each action type may be separately weighted. For example, printing a published content may have a greater weight than viewing the published content, because a consumer who performs a particular action such printing the content, such as a coupon, may go to the customer's store to redeem the coupon (thus driving business to the customer), whereas viewing the coupon shows a slight interest in the coupon, but may not be enough to get the consumer to go to the customer's store. One non-limiting, non-exhaustive example of an order of action types for a highest weight to a lowest weight may be: redeeming, printing, sharing, adding to a favorites list, reading, viewing, and searching. However, embodiments are not so limited and other weights, action types, ordering of weights, or the like may be employed. In various other embodiments, various combinations of action type may also be weighted. For example, sharing a coupon and printing a coupon if performed by the same consumer on the same published coupon may be weighted higher than only printing the coupon.

In at least one embodiment, the weights may be initially established by an administrator, sales representative, or the like. In at least one embodiment, the weights may be established by employing engineering judgment to determine which action types should be weighted higher than other action types. In various other embodiments, the weights may dynamically change over time. In at least one such embodiment, historical data and heuristics may be employed to determine if one action type is a better indicator of driving business to a customer than another action type. Taking coupons as an example, assume that historically 40% of consumers who share a coupon also redeem the coupon and that 35% of consumers who add a coupon to a favorites list also redeem the coupon. So in this example sharing may have a higher weight than adding to a favorites list. Over time, monitoring the actions by consumers may indicate a change such that 40% of consumer show share a coupon still redeems the coupon, but that 45% of consumers who add the coupon to a favorites list now redeem the coupon. This shift of redemption percentages may be utilized to modify the weights of the action types such that adding a coupon to a favorites list is now weighted higher than sharing the coupon.

Process 500 may continue to block 506, where statistics for each action type may be determined based on the monitored actions for each portion of published content. In some embodiments, the statistics for a particular portion of published content may include a ratio of the number of actions (per action type) to the number of impressions (i.e., number of times the particular published content was displayed to a consumer). In at least one of various embodiments, this ratio may be referred to as a conversion rate. In some embodiments, a conversion rate may be determined for each portion of published content for each action type.

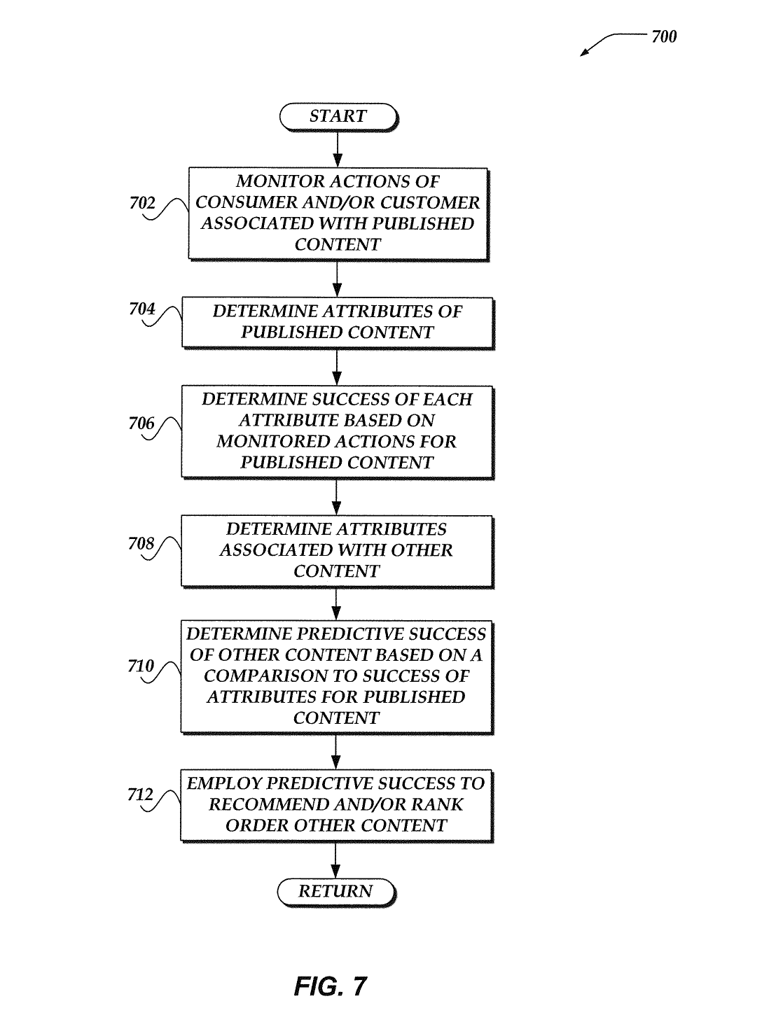

In some embodiments, statistics may also be determined for each attribute associated with the published content, which is described in more detail in conjunction with FIG. 7. Briefly, however, a design of experiments may be employed to utilize the monitored actions and the attributes of each portion of published content to statistically isolate the different attributes and determine which attributes attributed to a success of a portion of content (e.g., a high conversion rate for redeeming a coupon compared to a low conversion rate for redeeming a different coupon).

In any event, process 500 may proceed next to block 508, where a score may be determined for each portion of published content based on the determined statistics. In some embodiments, the score may be determined based on a combination of each action type statistic and their corresponding weights. In at least one of various embodiments, the score of a portion of content, such as, a coupon may be determined by the weighted average of the action type statistics. In another embodiment, the score may be the sum of the products of the action type statistics and their corresponding weights. However, embodiments are not so limited and other algorithms may be employed to determine a score of each portion of published content.

Process 500 may continue at block 510, where the ranked order of the plurality of content templates may be modified based on the published content scores. As described herein customers may select content for publication from a plurality of rank ordered content templates. In some situations a same content template may be selected by multiple customers. So, in some embodiments, each of the plurality of content templates (e.g., the initially ranked content at block 402 of FIG. 4) may be separately scored based on the published content scores associated with a corresponding content template. In at least one such embodiment, scores for published content that originated from a same content template may be combined (e.g., averaged) to determine a score for the content template. The scores of the content templates may then be utilized to modify the ranked order of the content (e.g., highest score to lowest score). In some embodiments, the plurality of content templates may be ranked order from highest score to lowest score. In other embodiments, the scores may be utilized to determine a rating for each content template. In yet other embodiments, the score may be utilized to arrange the content templates into buckets/groups, as described above.

After block 510, process 500 may return to a calling process to perform other actions.

FIG. 6 illustrates a logical flow diagram generally showing one embodiment of a process for modifying content templates based on consumer customizations of content templates. Process 600 begins, after a start block, at block 602, where a plurality of content templates may be determined. In some embodiments, the content templates may be generated by an administrator, sales agent, or the like.

In other embodiments, the content templates may be generated from previously published content, such as, a plurality of previously published coupons. These previously published coupons may have been generated and/or published by customers. In at least one of various embodiments, previously published content may be generalized into a content template. For example a previously published coupon for “25% off item_{—}1 at Restaurant_A” may be generalized and converted into a coupon template for “25% off an item” such that the restaurant's name and the particular item are removed. In some embodiments, the coupon template may include one or more tags of one or more categories. Expanding the example above, the 25% off coupon may be tagged with a “restaurants” category. This tag may indicate that the coupon template was generated from a coupon that was published for a restaurant, and may or may not limit the coupon templates use to restaurants.

Process 600 may proceed to block 604, where the plurality of content templates may be rank ordered and/or recommended to a customer. In at least one of various embodiments, block 602 may employ embodiments of block 402 of FIG. 4 to rank order a plurality of content templates.

Process 600 may continue at block 606, where the customer may be enabled to select and/or customize one or more content templates. In at least one of various embodiments, the customer may access one or more content templates through a graphical user interface. In some embodiments, the customer may utilize a web browser and/or web portal to access the templates.

In some embodiments, the customer may be provided one or more recommended content templates from which the customer can customize. In at least one of various embodiments, block 606 may employ embodiments of block 406 of FIG. 4 to determine which content templates to recommend to the customer (e.g., determine subset of the plurality of ranked content templates).

Customizing a content template may include, but is not limited to, modifying the template; adding text, images, or graphics; selecting additional predetermined attributes to be added to the template; changing a format (e.g., font, color, or layout); or the like. In other embodiments, a content template may be customized by adding/modifying a title/headline, adding a full description, creating an attribute of the content (e.g., for coupon templates, if the coupon template is for 30% off, the customer may be enabled to change it to 25% off), provide a limitation (e.g., coupon valid on Wednesdays only), include a validity expiration date/time, include a valid date range, including a geographic location for publishing the content, or the like.

Process 600 may proceed next to block 608, where the customized content may be published. In at least one of the various embodiments, block 608 may employ embodiments of block 408 of FIG. 4 to publish content.

Process 600 may continue next at block 610, where one or more content template may be modified based on the customer customizations. In at least one of various embodiments, each customer customization may be an interaction performed by a customer on a content template. In some embodiments, a plurality of customers may perform similar or same customizations on a same content template. In at least one such embodiment, the content template may be modified based on the similar or same customer customizations. For example, if a plurality of customers changes a 30% off coupon template to a 25% off coupon, then the coupon template may be modified to be 25% off instead of 30% off. In another embodiment, the coupon template may be modified to include an indicator that other customers previously customized the 30% off coupon to be 25% off. This indicator may inform a customer anonymously of how competitors may have changed the coupon template. In any event, the customization of a content template may be utilized as feedback for modifying the content template. In at least one of various embodiments, block 610 may be optional, and may not be performed.

Process 600 may proceed to block 612, where the ranked order of the content templates may be modified. In some embodiments, the ranked order of the templates may be modified based on the modifications/customizations made to one or more content templates. For example, in various embodiments, a content template that is modified based on customers customizations may indicate that the modified content template performs better (or is expected to perform better) than the unmodified content template. So the content template rankings may be modified to accommodate this change. In various embodiments, a score may be determined for each content template, including the modified content templates, for example by employing embodiments described herein in conjunction with FIG. 7. The score may be utilized to re-rank the plurality of content templates.

For example, in some embodiments, content, such as, a plurality of coupons may be ranked order from highest score to lowest score. In other embodiments, the scores may be utilized to determine a rating for each coupon. In yet other embodiments, the score may be utilized to or arrange the coupons into buckets/groups, as described above.

In some other embodiments, the ranked order of the content templates may be modified based on content scores as determined by process 500 of FIG. 5. In yet other embodiments, the ranked order may be modified based on a combination of the content template modifications and the content score (e.g., after a modified coupon template has been used to generate and publish coupons). For example, if a plurality of customers customizes a 20% off coupon template to be 25% off when published, and the number of consumers who printed the published coupon increases, then the 20% off coupon template may be modified and/or a rank of the coupon template may be increased.

After block 612, process 600 may return to a calling process to perform other actions.

FIG. 7 illustrates a logical flow diagram generally showing one embodiment of a process for determining and utilizing content attribute successes to rank order and/or recommend content templates. Process 700 begins, after a start block, at block 702, where a plurality of actions may be monitored for published content, such as, actions for each of a plurality of published coupons. In some embodiments, the actions may be performed by a consumer (e.g., sharing a coupon), customer (e.g., modifying content), or a combination thereof. Various embodiments of block 502 of FIG. 5 and/or block 606 of FIG. 6 may be employed to monitor actions of consumers and/or customers.

Process 700 may proceed to block 704, where attributes associated with the published content, such as, each published coupon may be determined. In at least one of various embodiments, the published content may be examined and the attributes extracted from the published content. In some embodiments, the attributes may be determined by comparing text of the published content with a database of known attributes. In other embodiments, the published content may include one or more tags (e.g., such as metadata of a coupon) that identify one or more attributes of the published content. In at least one embodiment, these tags may be associated with published content based on the content template utilized to generate the published content. For example, a published coupon may be generated from a coupon template that is includes and/or is tagged with the attributes 20% off and valid on Mondays. In this example, the published coupon may also be tagged with the attributes 20% off and valid on Mondays. In another embodiment, the tags may be selected and/or added by the customer when the customer generates content and/or modifies a content template.

Process 700 continues at block 706, where a success of each attribute may be determined based on the monitored actions. In some embodiments, the success of each attribute may be determined by employing one or more design of experiments that statistically isolate different attributes of content and their statistical significance. In some embodiments, the success of attributes may be determined based on the conversion rate of actions performed by the consumers (e.g., as described at block 506 of FIG. 5) on a plurality of portions of published content. In some embodiments, the success may be determined by employing weights for the different action types (e.g., as described at block 504 of FIG. 5).

In some embodiments, the content templates may be normalized based on different attributes. In some embodiments, attributes may include different classifications of attributes. These classifications may include, but are not limited to, behaviors; modifiers/reinforcements, limits, or the like. Behaviors may indicate what the consumer is getting out of the content. Examples of behaviors for content, such as, coupons may include, but are not limited to, “free something,” “dollars off something,” “something for dollars,” percent off something,” or the like. Modifiers/reinforcements may indicate a value or property of the product associated with the content. Examples of modifiers/reinforcements may include, but are not limited to, “dollar value of the product,” “regular price of product,” “value saved with coupon,” or the like. Limits may include restrictions on when the coupon may be valid/redeemable. Examples of restrictions may include, but are not limited to, “one coupon per table,” “Friday only,” “$50 maximum value,” “minimum spend $100,” or the like. Behaviors, modifiers/reinforcements, and limits may be employed in any combination with published content and each may be normalized to determine which attributes attributed to the success of the published content. The above attributes are examples, and should not be construed as being limiting or exhaustive.

In any event, process 700 may proceed to block 708, where attributes associated with other portions of published content (e.g., other coupons, banner ads, videos, or the like) may be determined. In some embodiments, the other content may include new content generated by a customer from a blank content template. In other embodiments, the other content may include content that may be customized by a customer from a content template. In other embodiments, the other content may include a plurality of coupons and/or coupon templates (e.g., coupon library) that can be recommended to a customer. In at least one of various embodiments, block 708 may employ embodiments of block 704 to examine the content, such as, other coupons to determine associated attributes.

Process 700 may continue at block 710, where a predictive success of each portion of other content may be determined. In at least one embodiment, the success of attributes (as determined at block 706) that match attributes of the other content may be employed to determine the predictive success. In at least one embodiment, the success of each attribute of the other content may be combined (e.g., averaged) to determine the overall predictive success of the other content.

Process 700 may proceed next to block 712, where the predictive success may be employed to recommend and/or rank order the other content, including coupons. If the other content is new/customized content, then the predictive success may be employed to rank the new/customized content with the plurality of content templates (e.g., as determined at block 402 of FIG. 4). This ranking may provide the customer with an indication of how well its new/customized content may perform compared to different other content. If the other content includes a plurality of unranked content templates, then plurality of unranked content templates may be rank ordered (e.g., at block 402 of FIG. 4) based on the predictive success. If the other content include a plurality of previously ranked content templates, then the plurality of ranked content templates may be re-ranked or the ranked order modified (e.g., at block 410 of FIG. 4) based on the predictive success.

In some embodiments, analytics based on the predictive success may be provided to a customer as a customer modifies a content template or creates new content from a blank template. For example, if a customer changes a 20% off coupon template to 25% off, then the predictive success of the customized coupon template may be based on the success the 25% off attribute when included with previously published coupons. It should be recognized that this is an example and other combinations of attributes and/or successes may be combined to determine the predictive success of a coupon (e.g., a customized coupon template) or other content. In any event, the successes of attributes may be utilized as feedback to dynamically modify content template rankings, provide real time updates for how customized content may perform, or the like.

After block 712, process 700 may return to a calling process to perform other actions.

In some embodiments, various combinations of processes 500, 600, and 700 of FIGS. 5, 6, and 7, respectively, may be employed to recommend coupon templates to a customer, rank order coupon templates, or the like.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

### Use Case Illustrations

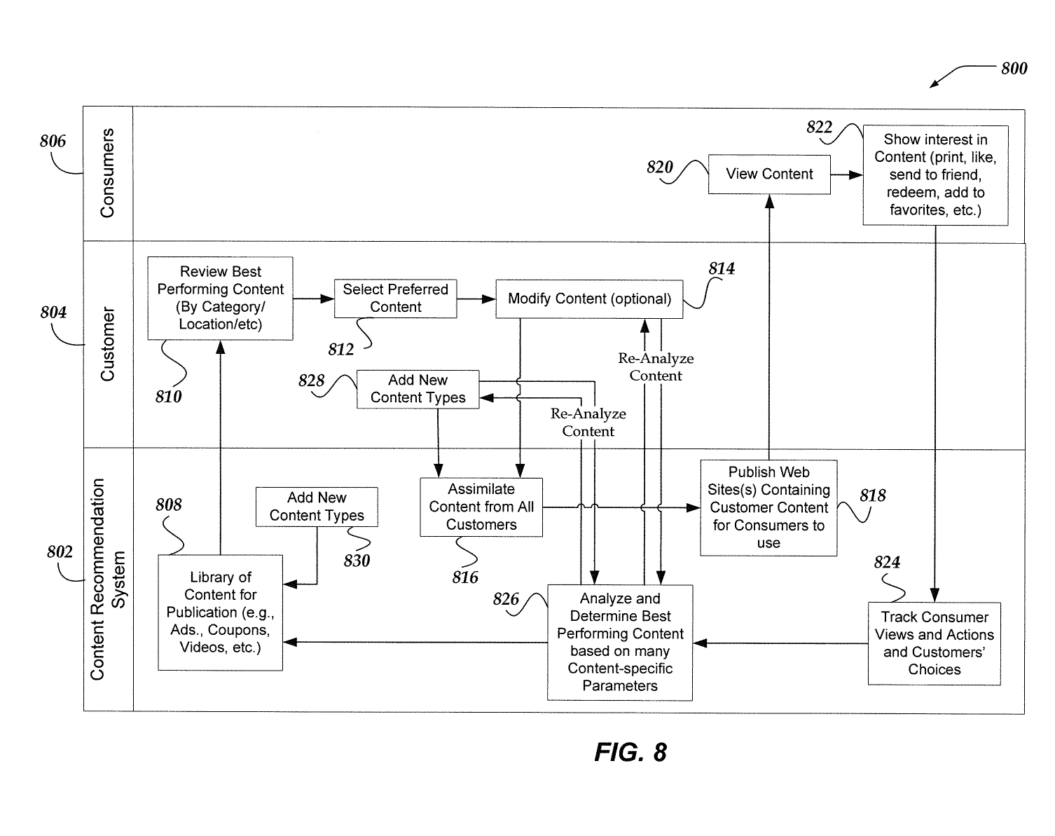

FIG. 8 shows a non-exhaustive example of a use case embodiment of a system-flow diagram generally showing embodiments for recommending content to customers for publication to consumers. Example 800 may include content recommendation system (CRS) 802, customer 804, and consumers 806. In some embodiments, CRS 802 may be implemented with or executed on one or more network devices, such as network device 300 of FIG. 3. In at least one of various embodiments, consumers 806 may include consumers of products of customer 804.

CRS 802 may maintain a library of content for publication (block 808). In at least one embodiment, this library may include a plurality of content that may be rank ordered by category. CRS 802 may provide the best performing content from the library to customer 804. In at least one embodiment, the best performing content may be a predetermined number of recommended content for customer 804 (e.g., the highest three ranking content pieces). In some embodiments, the best performing content may be determined by at least a category of customer 804 and/or a location determined by customer 804. Customer 804 may review the best performing content (block 810), and select one or more as preferred content that may be published to consumers 806 (block 812). In some embodiments, customer 804 may be enabled to modify the selected content (block 814) and/or add new content (block 828). In at least one of various embodiments, the modified/new content may be re-analyzed (block 826) with other content to predict how successful the modified/new content may be. In some embodiments, best performing content may be provided to, reviewed by, and/or selected/modified by a plurality of customers (from the same category and/or different categories).

CRS 802 may assimilate the selected (either modified and/or unmodified) content from one or more customers (block 816). CRS 802 may publish the selected content to consumers 806 (block 818) for consumers 806 to use. In some embodiments, the content may be published to one or more websites. Consumers 806 may view the published content (block 820), such as if the user accesses a webpage where the content is published. Consumers 806 may show an interest in the published content by performing an action on the published content (block 822). Examples of such actions may include, but are not limited to, printing the content, liking the content on a social media webpage, sending the content to a friend, redeeming the content (e.g., as a coupon), adding the content to a favorites list, or the like.

CRS 802 may track how many consumers 806 viewed the published content, how many consumers 806 performed an action on the published content, and what those actions were (block 824). In some embodiments, CRS 802 may also track the selections and/or modifications to the content by customer 804. By employing embodiments described above, CRS 802 may analyze actions for a plurality of different published content and determine which content performed the best (block 826). In some embodiments, CRS 802 may utilize specific attributes/parameters of the published content to determine the best performing content. In at least one embodiment, CRS 802 may score and/or rank the content to determine the best performing content. CRS 802 may update the library of content based on the determined best performing content (block 808). In some embodiments, CRS 802 may periodically or at predetermined times add new content to the library of content (block 830).

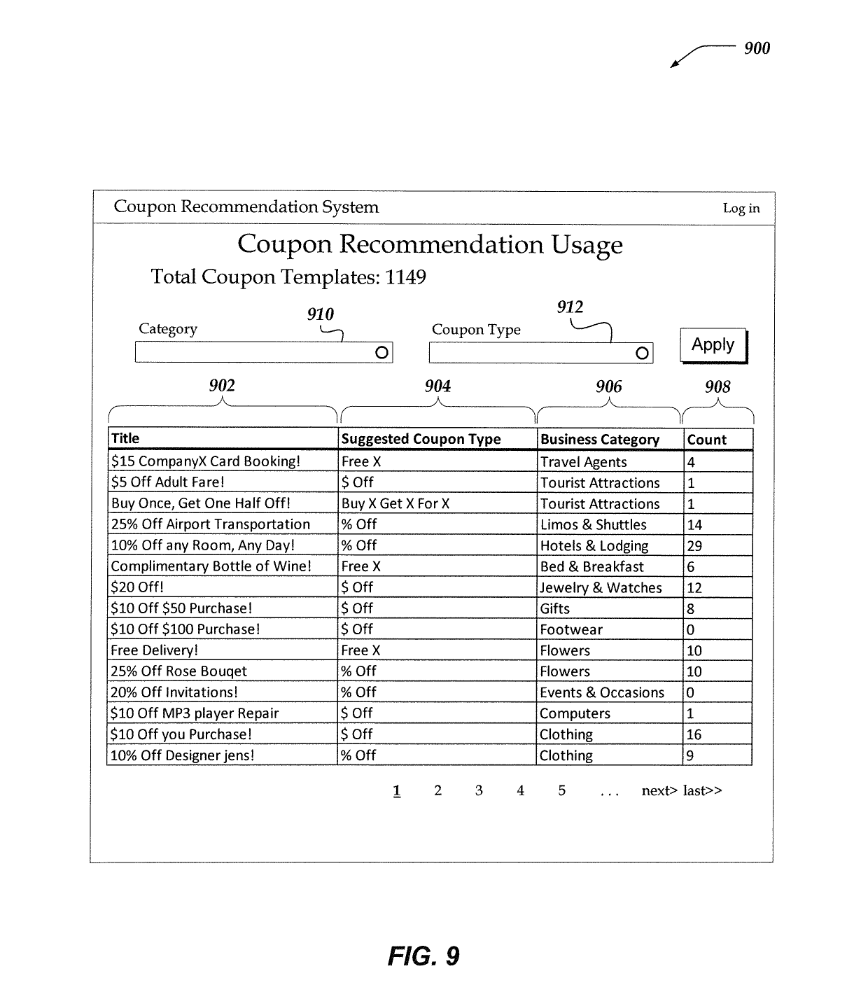

FIG. 9 shows a non-exhaustive example of a use case embodiment of a graphical user interface that may be utilized to view coupon templates and their rankings. Graphical user interface (GUI) 900 may be an example illustration of a browser window for a coupon recommendation system employing embodiments described herein. GUI 900 may include coupons 902, coupon type 904, category 906, and coupon 908. Coupons 902 may include a list of each of a plurality of coupon templates. In at least one of various embodiments, the order of the coupon templates listed under coupons 902 may indicate a ranking of coupons 902, where the top-listed coupon template has the highest ranking, the second-from-the-top-listed coupon template may be a second highest ranking, and so on.

Coupon type 904 may indicate a generic classification of each coupon template listed. In some embodiments, the coupon type may be one of a plurality of attributes associated with the coupon templates. Category 906 may include a category associated with each coupon template listed. Count 908 may indicate a number of customers that have selected each coupon template listed for publication. Although not illustrated, GUI 900 may include other columns of information regarding each coupon template. For example, GUI 900 may also include additional columns (not shown) that each indicate a number actions monitored for different actions types for each coupon template listed.

Category filter 910 may enable a customer to filter coupons 902 to show only those coupon templates with a corresponding category 906. Coupon type filter 912 may enable a customer to filter coupons 902 to show only those coupon templates with a corresponding coupon type 904. In some other embodiments, the customer may be enabled to log into a user account, which may automatically filter coupons 902 based on a predefined category of the customer by employing embodiments described herein.

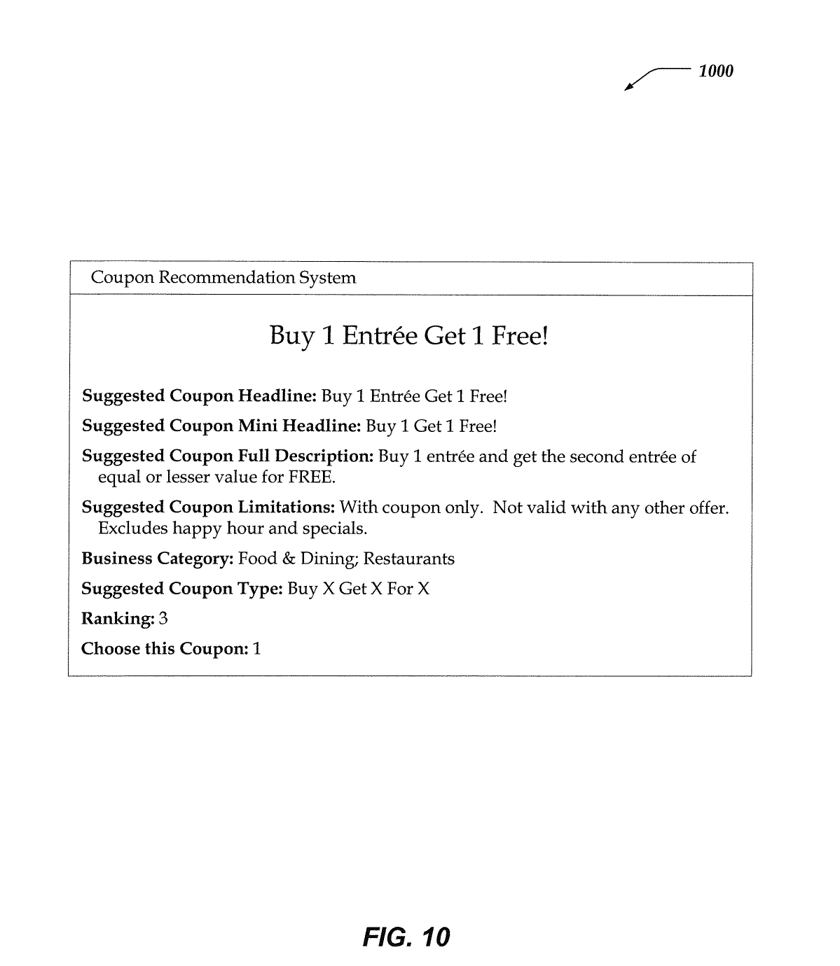

FIG. 10 shows a non-exhaustive example of a use case embodiment of a graphical user interface that displays coupon template information. Example 1000 may illustrate a coupon template that is recommended to a customer by employing embodiments described herein. As illustrated, the coupon template may include different attributes and/or information about the template, including but not limited to: a suggested coupon headline, a suggested coupon mini headline, a suggested coupon full description, a suggested coupon limitation, a business category, a suggested coupon type, a ranking, and a count.

Various items of information in the template may be suggested to the customer for use in publishing the coupon. The suggested coupon headline may be a headline that may be displayed when the coupon when is viewed by a consumer. The suggested coupon mini headline may be a mini headline that may be displayed in a link, SMS message, email message, webpage advertisement banner, or the like. The suggested coupon full description may be a description that may be displayed to a consumer if the consumer clicks on the coupon. The suggested coupon limitation may identify restrictions that can be applied to the coupon to indicate when the coupon is valid or invalid.

The business category may include one or more categories associated with the template coupon. The suggested coupon type may include one or more generic types of the coupon template. The ranking may be the current ranking of the coupon template. The count may be the number of other customers who have selected the template or the number of published coupons based on that template. As indicated the above are merely template suggestions and in some embodiments, the customer may be enabled to modify one or more of the information.

The above specification, examples, and data provide a complete description of the composition, manufacture, and use of the invention. Since many embodiments of the invention can be made without departing from the spirit and scope of the invention, the invention resides in the claims hereinafter appended.

1. A method for providing at least one coupon to a plurality of consumers over a network, wherein at least one network device performs actions, the actions comprising:
determining a ranked order of a plurality of coupon templates for each of a plurality of categories;
providing a subset of the plurality of coupon templates to a customer, wherein the subset of the plurality of coupon templates is determined based on at least a category of the customer and the ranked order of the plurality of coupon templates for the category;
publishing the at least one coupon from the subset of coupon templates to the plurality of consumers for products of the customer, wherein the at least one coupon is selected and finalized for publication by the customer;
employing a plurality of customer customizations from a plurality of different customers on at least one of the plurality of coupon templates for previously published coupons as feedback to modify the at least one of the plurality of coupon templates itself based on the plurality of customer customizations; and
modifying the ranked order of the plurality of coupon templates based on each modified coupon template and at least a plurality of monitored actions associated with the at least one published coupon.

2. The method of claim 1, wherein determining the ranked order of the plurality of coupon templates further comprises:
determining a success of each attribute associated with a plurality of previously published coupons based on a plurality of other monitored actions associated with the plurality of previously published coupons;
determining a score for each of the plurality of previously published coupons based on the success of attributes associated with a corresponding coupon; and
ranking the plurality of coupon templates based on corresponding coupon template scores that are each based on a combination of the scores for the plurality of previously published coupons that originated from a corresponding coupon template.

3. The method of claim 1, modifying the ranked order of the plurality of coupon templates further comprises:
determining a success of each attribute associated with the at least one published coupon based on the monitored actions; and
re-ranking the plurality of coupon templates based on a score of the at least one published coupon that is based on the success of each attribute associated with a corresponding coupon template.

4. The method of claim 1, wherein the monitored actions include interactions performed by at least some of the plurality of consumers on the at least one published coupon, including at least one of searching, viewing, clicking on, hovering over, printing, sharing, or redeeming the at least one published coupon.

5. The method of claim 1, wherein the monitored actions include interactions performed by the customer on the at least one published coupon.

6. The method of claim 1, further comprising:
enabling the customer to modify at least one coupon template; and
publishing the modified coupon template to the plurality of consumers.

7. The method of claim 1, wherein the subset of the plurality of coupon templates is further determined based on at least a weighted combination of the ranked order and at least one external variable that is unrelated to consumer actions associated with the subset of coupon templates.

8. The method of claim 1, wherein the subset of the plurality of coupon templates is further determined based on at least a third-party identified reputation of the customer.

9. The method of claim 1, wherein the customer is enabled to select a plurality of highest ranked coupon templates from the subset of coupon templates based on a single selection by the customer.

10. A processor readable non-transitory storage media that includes instructions for providing at least one coupon to a plurality of consumers over a network, wherein the execution of the instructions by a processor enables actions, comprising:
determining a ranked order of a plurality of coupon templates for each of a plurality of categories;
providing a subset of the plurality of coupon templates to a customer, wherein the subset of the plurality of coupon templates is determined based on at least a category of the customer and the ranked order of the plurality of coupon templates for the category;
publishing the at least one coupon from the subset of coupon templates to the plurality of consumers for products of the customer, wherein the at least one coupon is selected and finalized for publication by the customer;
employing a plurality of customer customizations from a plurality of different customers on at least one of the plurality of coupon templates for previously published coupons as feedback to modify the at least one of the plurality of coupon templates itself based on the plurality of customer customlzations; and
modifying the ranked order of the plurality of coupon templates based on each modified coupon template and at least a plurality of monitored actions associated with the at least one published coupon.

11. The media of claim 10, wherein determining the ranked order of the plurality of coupon templates further comprises:
determining a success of each attribute associated with a plurality of previously published coupons based on a plurality of other monitored actions associated with the plurality of previously published coupons;
determining a score for each of the plurality of previously published coupons based on the success of attributes associated with a corresponding coupon; and
ranking the plurality of coupon templates based on corresponding coupon template scores that are each based on a combination of the scores for the plurality of previously published coupons that originated from a corresponding coupon template.

12. The media of claim 10, modifying the ranked order of the plurality of coupon templates further comprises:
determining a success of each attribute associated with the at least one published coupon based on the monitored actions; and
re-ranking the plurality of coupon templates based on a score of the at least one published coupon that is based on the success of each attribute associated with a corresponding coupon template.

13. The media of claim 10, wherein the monitored actions include interactions performed by at least some of the plurality of consumers on the at least one published coupon, including at least one of searching, viewing, clicking on, hovering over, printing, sharing. or redeeming the at least one published coupon.

14. The media of claim 10, wherein the monitored actions include interactions performed by the customer on the at least one published coupon.

15. The media of claim 10, further comprising:
enabling the customer to modify at least one coupon template; and
publishing the modified coupon template to the plurality of consumers.

16. The media of claim 10, wherein the subset of the plurality of coupon templates is further determined based on at least a weighted combination of the ranked order and at least one external variable that is unrelated to consumer actions associated with the subset of coupon templates.

17. A system for providing at least one coupon to a plurality of consumers over a network, comprising:
at least one network device, including:
a memory for storing data and instructions; and
a processor that executes the instructions to enable actions, including:
determining a ranked order of a plurality of coupon templates for each of a plurality of categories;
providing a subset of the plurality of coupon templates to a customer, wherein the subset of the plurality of coupon templates is determined based on at least a category of the customer and the ranked order of the plurality of coupon templates for the category;
publishing the at least one coupon from the subset of coupon templates to the plurality of consumers for products of the customer, wherein the at least one coupon is selected and finalized for publication by the customer;
employing a plurality of customer customizations from a plurality of different customers on at least one of the plurality of coupon templates for previously published coupons as feedback to modify the at least one of the plurality of coupon templates itself based on the plurality of customer customization; and
modifying the ranked order of the plurality of coupon templates based on each modified coupon template and at least a plurality of monitored actions associated with the at least one published coupon.

18. The system of claim 17, modifying the ranked order of the plurality of coupon templates further comprises:
determining a success of each attribute associated with the at least one published coupon based on the monitored actions; and
re-ranking the plurality of coupon templates based on a score of the at least one published coupon that is based on the success of each attribute associated with a corresponding coupon template.

19. The system of claim 17, wherein the monitored actions include interactions performed by at least some of the plurality of consumers on the at least one published coupon, including at least one of searching, viewing, clicking on, hovering over, printing, sharing, or redeeming the at least one published coupon.

20. The system of claim 17, wherein the monitored actions include interactions performed by the customer on the at least one published coupon.

21. The system of claim 17, wherein the subset of the plurality of coupon templates is further determined based on at least a weighted combination of the ranked order and at least one external variable that is unrelated to consumer actions associated with the subset of coupon templates.

22. The system of claim 17, wherein the subset of the plurality of coupon templates is further determined based on at least a third-party identified reputation of the customer.

23. A network device for providing at least one coupon to a plurality of consumers over a network, comprising:
a memory for storing data and instructions; and
a processor that executes the instructions to enable actions, including:
determining a ranked order of a plurality of coupon templates for each of a plurality of categories;
providing a subset of the plurality of coupon templates to a customer, wherein the subset of the plurality of coupon templates is determined based on at least a category of the customer and the ranked order of the plurality of coupon templates for the category;
publishing the at least one coupon from the subset of coupon templates to the plurality of consumers for products of the customer, wherein the at least one coupon is selected and finalized for publication by the customer;
employing a plurality of customer customizations from ra plurality of different customers on at least one of the plurality of coupon templates for previously published coupons as feedback to modify the at least one of the plurality of coupon templates itself based on the plurality of customer customizations; and
modifying the ranked order of the plurality of coupon templates based on each modified coupon template and at least a plurality of monitored actions associated with the at least one published coupon.

24. The network device of claim 23, wherein determining the ranked order of the plurality of coupon templates further comprises:
determining a success of each attribute associated with a plurality of previously published coupons based on a plurality of other monitored actions associated with the plurality of previously published coupons;
determining a score for each of the plurality of previously published coupons based on the success of attributes associated with a corresponding coupon; and
ranking the plurality of coupon templates based on corresponding coupon template scores that are each based on a combination of the scores for the plurality of previously published coupons that originated from a corresponding coupon template.

25. The network device of claim 23, modifying the ranked order of the plurality of coupon templates further comprises:
determining a success of each attribute associated with the at least one published coupon based on the monitored actions; and
re-ranking the plurality of coupon templates based on a score of the at least one published coupon that is based on the success of each attribute associated with a corresponding coupon template.

26. The network device of claim 23, wherein the monitored actions include interactions performed by at least some of the plurality of consumers on the at least one published coupon, including at least one of searching, viewing, clicking on, hovering over, printing, sharing, or redeeming the at least one published coupon.

27. The network device of claim 23, wherein the monitored actions include interactions performed by the customer on the at least one published coupon.

28. The network device of claim 23, further comprising:
enabling the customer to modify at least one coupon template; and
publishing the modified coupon template to the plurality of consumers.

29. The network device of claim 23, wherein the subset of the plurality of coupon templates is further determined based on at least a weighted combination of the ranked order and at least one external variable that is unrelated to consumer actions associated with the subset of coupon templates.

30. The network device of claim 23, wherein the customer is enabled to select a plurality of highest ranked coupons templates from the subset of coupon templates based on a single selection by the customer.
